(19) United States
(12) Patent Application Publication
(10) Pub. No.: US 2026/0289579 A1
(43) Pub. Date: Sep. 24, 2026

(54) CARBON HUB QUANTIFICATION FRAMEWORK

(71) Applicant: Halliburton Energy Services, Inc., Houston, TX (US)

(72) Inventors: Glenn WILSON, Houston, TX (US); Duane SHERRITT, Spring, TX (US); Misty DAVIS, Humble, TX (US); Ming ONGKWAN, Houston, TX (US)

(73) Assignee: Halliburton Energy Services, Inc., Houston, TX (US)

(21) Appl. No.: 19/086,365

(22) Filed: Mar. 21, 2025

(51) Int. Cl. G06Q 30/018; G06F 16/27

(52) U.S. Cl. CPC G06Q 30/018; G06F 16/27

(57) ABSTRACT

Aspects of the subject technology relate to systems, methods, and computer-readable media for accounting for the CO₂ in a carbon hub network that can include more than one capture facility, and/or more than one transport provider, and/or more than one storage provider. In some aspects, a method of the disclosed technology includes facilitating recording of capture data captured at one or more emitters related to performing a carbon capture utilization and storage (CCUS) process to a distributed ledger; facilitating application of a set of rules to the capture data and the storage data to verify that the CCUS process is compliant with a regulation; and minting a token attributed to the emitter on the distributed ledger based on verification that the CCUS process is compliant with the regulation, the token assuring regulatory compliance with the regulation.

### BACKGROUND

### Technical Field

The present disclosure generally relates to providing assurance of regulation compliance in a carbon capture utilization and storage (CCUS) process, and more specifically to providing assurance of regulation compliance in a CCUS process through a distributed ledger.

### Introduction

CCUS is the process of capturing and storing carbon dioxide (“CO₂”) from the environment and permanently preventing that CO₂ from entering or returning to the atmosphere. In some examples, CO₂ can be captured from the atmosphere, the ocean, or from an industrial process, among others. CO₂ can be utilized for a specific purpose, such as enhanced oil recovery (“EOR”), manufacturing chemicals, or producing durable products, for example. The captured CO₂ can be permanently stored in geological formations (i.e., in saline aquifers or depleted oil and gas reservoirs, for example).

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a schematic diagram of an example wellbore operating environment, according to some examples of the present disclosure;

FIG. 2 illustrates a schematic representation of a CCUS environment, according to some examples of the present disclosure;

FIG. 3 illustrates an exemplary blockchain network environment, according to some examples of the present disclosure;

FIG. 4 illustrates an exemplary carbon hub network environment, according to some examples of the present disclosure;

FIG. 5 illustrates a flow diagram of an example process for minting a token attributed to an emitter on the distributed ledger based on verification that the CCUS process is compliant with the regulation, according to some examples of the present disclosure;

FIG. 6 illustrates an example processor-based system with which some aspects of the subject technology can be implemented, according to some examples of the present disclosure;

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As discussed previously, a CCUS is a process of capturing carbon dioxide emissions from the environment and storing it to reduce the amount of carbon dioxide that enters the atmosphere. The CCUS process can include a single capture facility (or “emitter”), a single pipeline transport, and a single storage facility. In some examples, the storage facility can consists of injection and monitoring wells. A CCUS operator can perform monitoring, reporting and verification (“MRV”) and/or measurement monitoring and verification (“MMV”) to validate that a specific amount of CO₂ (for example, 1 metric ton of CO₂) has been captured and either utilized or stored. In order to provide a transparent, auditable process for verifying the reported CO₂ utilization and/or storage, a governance can be provided for performing MMV and/or MRV.

In other examples, the CCUS process can include multiple capture facilities (or “emitters”), multiple pipeline transport providers, and multiple storage facilities. For example, a carbon hub can comprise a network including more than one emitter, more than one transport provider, and/or more than one storage provider. However, can be challenging to account for CO₂ in these carbon hub networks due to multiple parties involved in the process. In particular, an accounting rule to relate the storage data to the specific capture facility that captured the CO₂ among multiple parties or attribute ownership of captured CO₂ (for the purpose of filing 45Q tax credits, for example) between a plurality of parties can be complicated and difficult. As follows, a method of accounting for the CO₂ in a carbon hub network that may include more than one capture facility (“emitter”), and/or more than one transport provider, and/or more than one storage provider is needed. In particular, a method of accounting that can relate the storage data (i.e., the CO₂ stored, etc.) to the specific capture facility (“emitter”) that captured the CO₂ is needed.

The disclosed technology addresses the foregoing by providing an assurance of regulation compliance, through a distributed ledger, in a CCUS process that involves a carbon hub with multiple capture facilities, multiple transport systems, and/or multiple storage facilities. For example, the disclosed technology can facilitate application of a set of rules for regulatory compliance and accounting rules (e.g., based on a function of time) and mint a token attributed to an appropriate capture facility on a distributed ledger based on the verification that the CCUS process is compliant with a regulation(s). In some examples, the carbon hub network can be used for tokenization via a distributed and decentralized ledger that provides immutable/non-fungible data records with transparency and auditability. A distributed and decentralized ledger can be utilized to allow multiple parties to transact with each other by providing identical records of the transactions to all parties. Parties can trade digital tokens, and/or verify the validity of the data, and/or vote on proposed claims. Since all parties can access the same data, it can be assured that data related to the transactions are true and correct, without relying on an external third party.

On example method of accounting to relate the storage data (i.e., the amount of CO₂ stored, etc.) to the specific capture facility (“emitter”) that captured the CO₂ includes utilizing the transport provider as a source of inventory that can track the flow of CO₂ through the pipeline. For example, one or more flow meters can be positioned at the input and at the output of the transport provider to track the input and output of CO₂ through the transport facility and associate a timestamp with the measured volume of CO₂. In this manner, accounting rules can be created that can attribute the CO₂ flowing through the transport facility to the specific capture facility that provided that CO₂ to the transport facility based on timestamp data (or any other data capable of distinguishing between more than one capture facility).

In a carbon hub network, a capture token can be minted when a capture facility captures and verifies the capture of a specific amount of CO₂ (for example, 1 metric ton of CO₂). However, in some examples, the carbon hub network can comprise more than one capture facility providing CO₂ to the transport facility. In this example, it is necessary to track the amount of CO₂ that each capture facility provides to the transport facility in order to determine which capture facility has captured the necessary amount of CO₂ to mint a capture token. In some examples, a flow meter and/or a composition meter can be positioned at the transport facility to verify that a specific amount of CO₂ (for example, 1 metric ton of CO₂) has been captured and transferred to the transport system.

In addition to the compliance principles applied to the collected data prior to minting a first capture token, an accounting principle can also be adopted for the CO₂ inventory in the transport system to associate the captured CO₂ with the capture facility that captured it. In one example, a time-stamped first in, first out (“FIFO”) rule can be applied to demonstrate that a first amount of CO₂ added to inventory is the first amount of CO₂ removed from inventory. This accounting rule can enable the linkage of the capture token to storage and injection tokens, and can unlock a CCUS token. This CCUS token can contain all the data collected from capture to storage (or utilization) that is required for the purpose of verifying that a first amount of CO₂ been captured and stored. Subsequently, if it is determined that all the CCUS token data are compliance with pre-defined regulatory and/or permit requirements, a second CCUS token can be minted. This second CCUS token can be monetized as a fiscal token that can be sold or otherwise monetized.

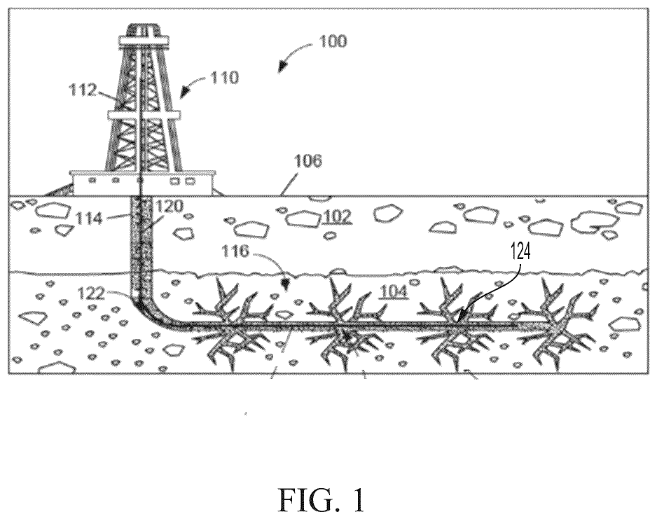

FIG. 1 illustrates a schematic diagram of an example wellbore operating environment 100. As depicted in FIG. 1, the operating environment 100 includes a wellbore 114 that penetrates a formation 102 for the purpose of recovering hydrocarbons, storing hydrocarbons, injecting water or carbon dioxide, or the like in formation 104. In certain embodiments, the purpose of the operating environment 100 is carbon capture and storage (CCS) and includes equipment associated with that purpose (not shown in FIG. 1). In certain embodiments, the purpose of the operating environment 100 is geothermal energy capture and includes equipment associated with that purpose (not shown in FIG. 1).

As depicted in FIG. 1, formations 102 and 104 are subterranean formations, although it is noted that formations 102 and 104 may be subsea formations. In certain locations, there are a plurality of underground formations 102, 104. The wellbore 114 may extend substantially vertically away from the Earth's surface 106 over a vertical wellbore portion, or may deviate at any angle from the Earth's surface 106 over a deviated or horizontal wellbore portion 116. In alternative operating environments, portions or substantially all of the wellbore 114 may be vertical, deviated, horizontal, and/or curved. The wellbore 114 may be drilled into the formations 102, 104 using any suitable drilling technique. As shown, a drilling or servicing rig 110 disposed at the surface 106 (which may be the surface of the Earth, a seafloor surface, or a sea surface) comprises a derrick 112 from which a tubular string 120 (e.g., a drill string, a tool string, a segmented tubing string, a jointed tubing string, or any other suitable conveyance, or combinations thereof) is positioned within or partially within the wellbore 114. The tubular string 120 may include two or more concentrically positioned strings of pipe or tubing (e.g., a first work string may be positioned within a second work string). The drilling or servicing rig 110 may include a motor driven winch and other associated equipment for lowering the tubular string into the wellbore 114. Alternatively, a mobile workover rig, a wellbore servicing unit (e.g., coiled tubing units), or the like may be used to lower the work string into the wellbore 114. In such an environment, the tubular string 120 may be utilized in drilling, stimulating, completing, or otherwise servicing the wellbore, or combinations thereof. A drilling or servicing rig 110 may also comprise other equipment. In certain types of operations, a fluid 122 is forced down the tubular string 120 and out through perforations 124 to fracture the formations 104 that surround the perforations 124.

While FIG. 1 depicts a stationary drilling rig 110, one of ordinary skill in the art will readily appreciate that mobile workover rigs, stimulation units (such as fracturing pumps), wellbore servicing units (such as coiled tubing units), and the like may be employed. It is noted that while the figures or portions thereof may exemplify horizontal or vertical wellbores, the principles of the presently disclosed apparatuses, methods, and systems, may be similarly applicable to horizontal wellbore configurations, conventional vertical wellbore configurations, deviated wellbore configurations, and any combinations thereof. The horizontal, deviated, or vertical nature of any figure is not to be construed as limiting the wellbore to any particular configuration or formation.

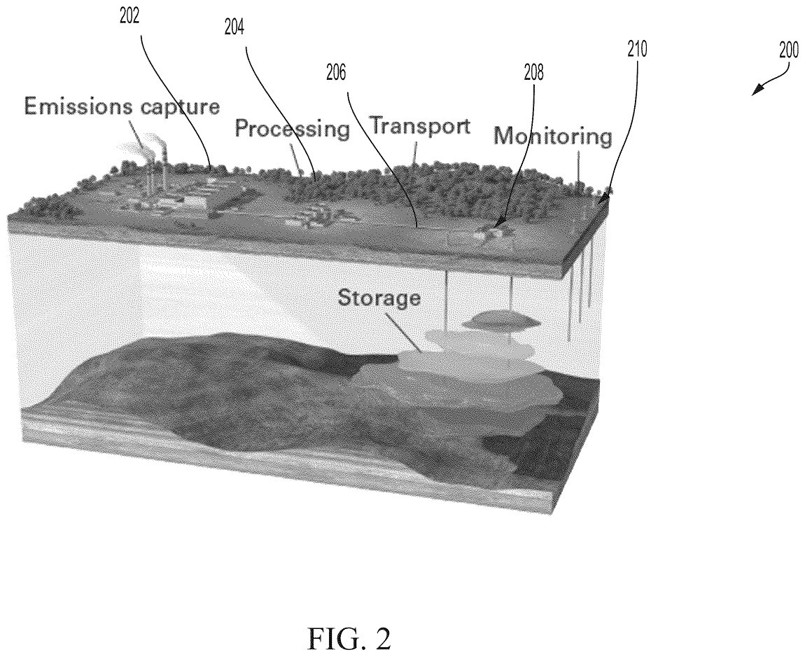

The disclosure now turns to a description of FIG. 2, which illustrates a schematic representation of a CCUS environment 200. The CCUS environment 200 comprises a capture facility 202, a processing facility 204, a transport system 206, a storage system/facility 208, and a monitoring system 210. The CCUS environment 200 is a simplified depiction of a CCUS environment and a CCUS environment can comprise multiple capture facilities, multiple processing facilities, multiple transport systems, multiple storage facilities, and multiple monitoring systems. Specifically, a CCUS environment can comprise one or more CCUS hubs. Hubs can comprise a transportation system/infrastructure that is shared by many capture facilities and many storage facilities, essentially acting as a central point for capturing and storing large volumes of carbon dioxide from a cluster of industries.

The capture facility 202 functions to capture carbon dioxide for purposes of storage. Specifically, the carbon capture facility captures carbon dioxide (CO₂), otherwise referred to as carbon herein, from industrial emissions, e.g. at power plants or factories, before it enters the atmosphere. For example, a coal fired power station can recover and fiscally meter carbon dioxide from a post combustion capture facility that would otherwise be vented to the atmosphere.

The processing facility 204 functions to process captured carbon for transportation through the transportation system to the storage facility 208. Specifically, the processing facility 204 can process captured carbon into a form that is suitable for transport over large distances to a storage facility. For example, the processing facility 204 can receive a gas stream of CO₂ that is processed into high purity CO₂, which is then dried, and compressed for transportation.

The transport system 206 functions to transport the carbon dioxide safely and efficiently from the processing facility 204 and capture facility 202 to the storage facility 208. The transport system 206 can comprise applicable systems from transporting carbon dioxide, such as rail, trucks, and pipelines. A pipeline should operate within a specific range of temperatures, pressures and flow rates along the way. Accordingly, the transport system 206, as will be discussed in greater detail later, can comprise sensors that measure these parameters for flow assurance. Further, the transport system 206 can comprise sensors that monitor carbon dioxide tonnage within the pipeline network to ensure that what was captured is delivered to its end destination at the storage facility 208.

The storage facility 208 is a site where captured carbon dioxide is permanently stored, effectively removing it from the atmosphere. For example, the storage facility 208 can be a geological formation into which carbon dioxide is injected and permanently stored. The storage facility 208 can comprise sensors to monitor the injected carbon to ensure that the tonnages of carbon dioxide injected/stored at the storage facility 208 matches what was delivered to the storage facility 208.

The monitoring system 210 functions to monitor the stored carbon dioxide to ensure that the carbon dioxide is stored safely and does not impact the environment. Specifically, the monitoring system 210 can validate that the carbon dioxide remains stored in the formation and does not migrate from the permitted geological store and into the surrounding area. The monitoring system 210 can comprise applicable sensors for monitoring stored carbon dioxide. Specifically, the monitoring system 210 can comprise CO₂ concentration detectors to measure the level of carbon dioxide in the surrounding environment, identifying potential leaks from the storage site. Example monitoring sensors include optical CO₂ sensors, atmospheric CO₂ tracers, eddy covariance flux measurement systems, and ground-based remote sensing to monitor the plume of CO2 above the storage area.

Real-time or near real-time monitoring from points of capture to storage can be used to ensure that the entire system remains compliant with various regulations, e.g. Environmental Protection Agency (EPA) class six compliance. End-to-end monitoring also advises on system level operations to reduce risk and drive operational efficiencies. Therefore, all of the capture facility 202, the processing facility 204, the transport system 206, the storage facility 208, and the monitoring system 210 can includes sensors for measuring CO₂, temperatures, pressure, and other applicable sensors, e.g. composition flow meters, that can be used to quantify unit masses of CO₂. Sensors in the CCUS environment 200 can require calibration, e.g. to ensure compliance with various regulations. Specifically, sensors can be calibrated every six months, 12 months, etc. This can ensure that accurate measurements are made with respect to CCUS operations.

Real-time, as used herein, can be defined as near instantaneous (e.g., consider sampling rates, etc.) and can include latency in communication (e.g., telemetry, etc.). For example, real-time can be instantaneous if communication between a controller and models are of zero latency. However, if the communication between a controller and models has as latency of 1 minute then real-time can be instantaneous plus 1 minute. In general, real-time means instantaneous plus latency or other system delay time. Other system delay time can include transmission time delay, acquisition time delay, processing time delay, or other system delays.

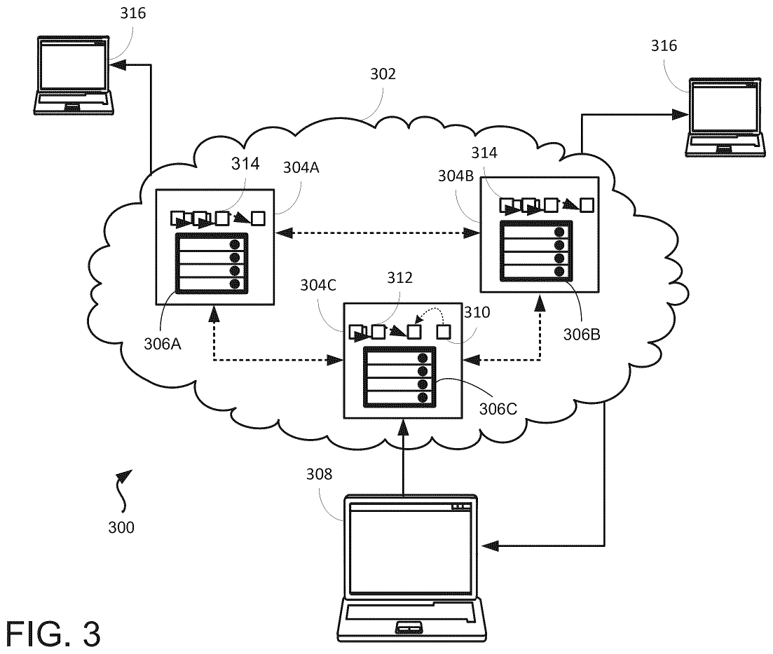

The disclosure turns now to FIG. 3, which shows an exemplary blockchain network environment 300, according to some examples of the present disclosure. While reference is made to the blockchain network environment 300 shown in FIG. 3, the technology described herein can be implemented on an applicable distributed ledger, including the blockchain represented in FIG. 3. Further, while FIG. 3 depicts one specific blockchain network environment 300 of the present disclosure, it is by no means the only blockchain network architecture on which the concepts herein can be implemented, as would be appreciated by one of ordinary skill in the art. Additionally, although blockchain network 300 is shown as comprising only a first blockchain, this is for purposes of clarity and it is appreciated that blockchain network 300 can comprise one or more additional blockchains without departing from the scope of the present disclosure.

Returning to FIG. 3, as shown, blockchain network 302 includes blockchain nodes 304A-C, which implement and maintain one or more blockchains of the present disclosure. These one or more blockchains are accessed and/or written to by one or more terminals 308 and 316. It is appreciated that a greater or lesser number of blockchain nodes 304A-C and terminals 308, 316 can be provided as desired without departing from the scope of the present disclosure. Additionally, although the blockchain nodes 304A-C are shown as being implemented on corresponding servers 306A-C, one or more of the blockchain nodes 304A-C in some embodiments may instead or also be an executable software application on a server and/or personal computer, a virtual machine, and the like. In instances where multiple blockchains are provided, the same blockchain nodes (e.g., nodes 304A-C) may implement each blockchain, or different groupings and combinations of blockchain nodes can be utilized to implement different blockchains, without departing from the scope of the present disclosure.

Each blockchain node 304A-C may intercommunicate and store copies of blockchains and similar data objects in local memory and/or in a remote memory or a data store. In some embodiments, each node 304A-C may store copies of each blockchain on the blockchain network 302, and access the blockchain network 302 and respective blockchain on an as needed basis.

Terminals 308 and 316 interact with blockchain network 302 via, for example, the Internet or some other communication network, public or private, wired or wireless. For purposes of example, as shown in FIG. 3, terminal 308 may update one or more stored blockchains within blockchain network 302 by transmitting an event transmission, record object, or other signal to node 304C within blockchain network 302. Node 304C may then process the received transmission in order to generate a new block 310 which can be added onto a respective blockchain 312. In some examples, there may be processes for randomizing which node assumes authority to update the blockchain such as, for example, a mining algorithm and the like (e.g., solving an easily verifiable but difficult to solve cryptographic puzzle such as determining appended characters which will cause a hash value to have a particular quality). In other examples, certain or all nodes may be granted authority to update blockchains by the system and any updates produced are taken presumed authentic and authoritative.

Node 304C may then transmit an updated blockchain 314 to each other node 304A-B in blockchain network 302. Updated blockchain 314 may include previous blockchain 312 with the new block 310 appended. In this manner, updated blockchain 314 may reflect a sequential expansion of the associated blockchain and may replace previous copies (e.g., copies not including new block 310) stored on a given node.

In some embodiments, the functionality of the above described blockchain nodes 304A-C and terminals 308, 316 can be combined, such that a single computing entity, whether physical or virtual, both implements a blockchain in concert with other blockchain nodes while also reading from and writing to that blockchain as desired.

In some embodiments, the blockchain network 302 (and the blockchain nodes 304A-C) may be implemented in a private fashion. In some embodiments, the blockchain network 302 might be implemented in private fashion, but by a third-party external to CCUS, such that the entities associated with CCUS operations only the access terminals 308, 316 for reading and writing to blockchains provided in a private blockchain cloud hosted by the external third-party. In some embodiments, the blockchain network 302 might be implemented as a public blockchain network, wherein one or more of the blockchain nodes 304A-C are not associated with a specific CCUS environment and are instead provided for example on the Internet.

In order to provide blockchain-based auditing, a plurality of blockchains can be implemented to provide a trusted permissioned ledger and repository. In some embodiments, one blockchain will be created for each entity associated with the CCUS process. In this manner, auditing and maintenance information otherwise independently collected and maintained by each entity is instead collated across entities and stored in a corresponding blockchain in a seamless and secure fashion, providing appropriately permissioned on-demand access to stored auditing information while simultaneously enforcing privacy, anonymization, and other functions across the entities.

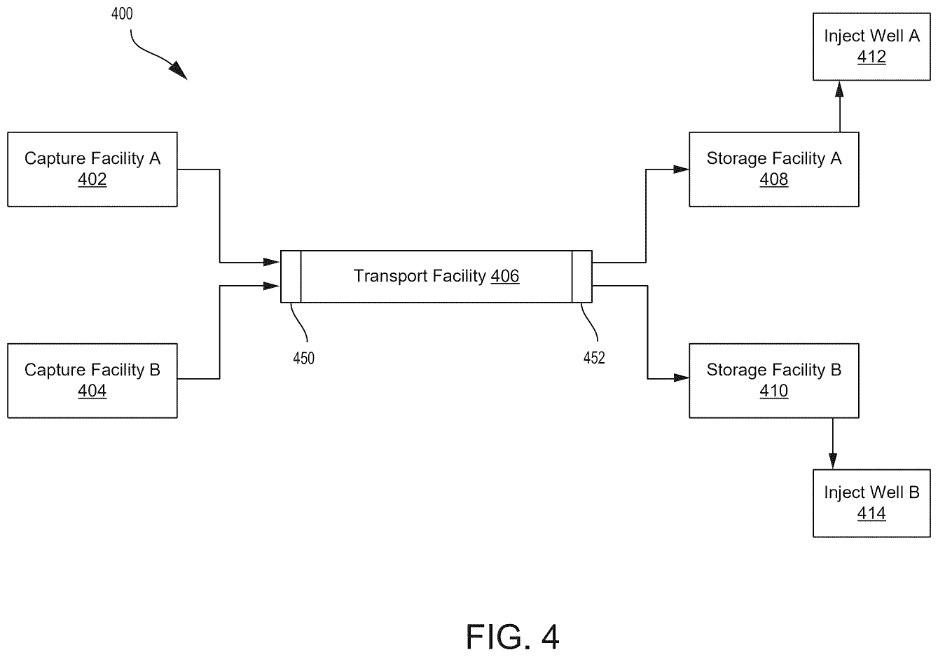

The disclosure turns now to FIG. 4, which shows an exemplary carbon hub network environment 400, according to some examples of the present disclosure. Carbon hub network environment 400 includes capture facility A 402 and capture facility B 404 (similar to capture facility 202 as illustrated in FIG. 2), which are separate carbon capture facilities that can both provide captured CO₂ to transport facility 406. Although FIG. 4 illustrates two capture facilities (capture facility A 402 and capture facility B 404), it is understood that carbon hub network environment 400 can include more than two capture facilities providing captured CO₂ to transport facility 406. Transport facility 406 (similar to transport system 206 as illustrated in FIG. 2) can include one or more input meters 450 and one or more output meters 452. In some examples, input meter 450 and/or output meter 452 can comprise CO₂ flow meters, composition meters, and/or any other known meter to measure and record any data related to the CO₂ transfer and identification.

As previously illustrated, a CCUS process can include an applicable process that is performed during carbon capture, utilization, storage, and monitoring. For example, a CCUS process can comprise the actual capture of carbon dioxide, the transportation of carbon dioxide to a storage site, and the injection of the captured carbon into the storage site. An entity associated with performing a CCUS process can comprise an entity who actually performs the CCUS process. Further, an entity associated with performing a CCUS process can comprise an entity that facilitates performance of the CCUS process. For example, entities associated with a CCUS process can comprise an owner of a factory that emits carbon dioxide and a third party that is responsible for capturing the emitted carbon dioxide. Further, an entity associated with performing a CCUS process can comprise an auditor for performing an independent examination of the CCUS process, e.g. to verify regulation compliance.

Input meter 450 and output meter 452 of transport facility 406 can track and record the amount of the CO₂ provided to the transport facility 406 as well as the source (i.e., specific capture facility) of the CO₂ as described in more detail below. Transport facility 406 can subsequently provide the captured CO₂ to one or more storage facilities (i.e., storage facility A 408 and/or storage facility B 410 (similar to storage facility 208 as illustrated in FIG. 2)) for storage or utilization. In some examples the one or more storage facilities can further provide the captured CO₂ to one more inject wells (i.e., inject well A 412 and/or inject well B 414). It is understood that although FIG. 4 illustrates two separate storage facilities (i.e., storage facility A 408 and storage facility B 410) and two separate inject wells (i.e., inject well A 412 and inject well B 414), that the carbon hub network environment 400 is not limited to two capture facilities, two storage facilities, or two inject wells, and can comprise any number of each. Additionally, carbon hub network environment 400 can include more than one transport facility.

In one example, the amount of captured CO₂ provided to the transport facility 406 can be attributed to the capture facility that provided the CO₂ (such as, for example, capture facility A 402 or capture facility B 404) using one or more accounting principles. For example, a time-stamped first in, first out (“FIFO”) rule can be applied to demonstrate that the first specific amount of CO₂ (i.e., 1 metric ton of CO₂) added to inventory (e.g., transport facility 406) corelates to first specific amount of CO₂ (i.e., 1 metric ton of CO₂) removed from inventory (e.g., transport facility 406). Alternative any accounting rules can be implemented, including but not limited to a first in first out (“LIFO”) rule that can account for the captured CO₂. The data can be measured via the one or more input meters 450 and one or more output meters 452 of transport facility 406.

In some examples, the carbon hub network 400 can be used for tokenization via a distributed and decentralized ledger that provides immutable/non-fungible data records with transparency and auditability, and therefore it can be important to track which capture facility (i.e., storage facility A 408 or storage facility B 410) has provided which amount of CO₂ in order to properly assign ownership to a given token. In some examples, a token can be defined as representing the capture of one metric ton of CO₂. In some examples, the token minting process can be initiated on a CO₂ mass basis (for example, 1 metric ton of CO₂ is captured or stored). In other examples, the token minting process may be initiated based on a time basis (for example, 32.5 tokens can be minted representing 32.5 metric tons of CO₂ being captured or stored over a 1 hour period). In carbon hub network 400, a capture token can be minted when a capture facility (i.e., storage facility A 408 or storage facility B 410) captures (and verifies the capture of) a specific amount of CO₂ (i.e., 1 metric ton of CO₂) and transfers that CO₂ to the transport facility (transport facility 406).

For example, input meters 450 of transport facility 406 can comprise a combination of a flow meter and a composition meter that can verify that a specific amount of CO₂ (i.e., 1 metric ton of CO₂) has been captured and transferred to the transport facility 406. The capture token can contain additional storage data related to the capture facility (capture facility A 402 and capture facility B 404) such as identification numbers, permit numbers, prevailing wage, apprenticeship information, etc. The transport facility 406 can track the inventory of CO₂ (e.g., the mass of CO₂ in a pipeline, or the mass of CO₂ on a ship).

In carbon hub network 400, a storage token can also be minted when a storage facility (i.e., storage facility A 408 and/or storage facility B 410) assumes delivery of a specific amount of CO₂ (i.e., 1 metric ton of CO₂) from the transport facility 406. For example, output meters 452 of transport facility 406 can comprise a combination of a flow meter and/or a composition meter to verify that a specific amount of CO₂ (i.e., 1 metric ton of CO₂) has been received from the transport facility 406. The storage token can contain additional storage data related to the storage facility (i.e., storage facility A 408 or storage facility B 410) such as identification numbers, permit numbers, surface pressures, temperatures, or any other data required or useful for any regulatory compliance. The storage token can also contain an identifier if the storage site is used for permanent storage or for utilization (e.g., EOR). Additionally, in some examples, an injection token can be minted when a storage facility (i.e., storage facility A 408 or storage facility B 410) injects a specific amount of CO₂ (i.e., 1 metric ton of CO₂) into an injection well (i.e., inject well A 412 and/or inject well B 414). The injection token can further contain additional injection data related to the wells (e.g., pressures, temperatures, or any other data required or useful for any regulatory compliance such as Class VI permit).

The accounting rules discussed above can enable the linkage of the capture token to the storage and injection tokens, thereby unlocking a CCUS token. In some examples, a first set of rules can be applied to the data to verify the CCUS process is compliant with a first regulation. Regulations, as used herein, can comprise applicable rules and standards that are defined and followed in relation to an aspect of carbon sequestration operations. The first set of rules corresponding to the first regulation can comprise a regulation that is fiscally agnostic. Fiscally agnostic, as used herein, can comprise the state of being independent of a position in a value structure or otherwise not acting as a security. Specifically, the first set of rules can comprise one or more rules related to measuring and verifying an amount of carbon captured at a capture site. For example, the first regulation can comprise EPA subpart PP. Further, the first set of rules can comprise one or more rules related to storing and verifying an amount of carbon stored at a storage site. For example, the first regulation can comprise EPA subpart RR. Additionally, the first set of rules can comprise one or more rules related to monitoring and verifying continued storage of the amount of carbon at the carbon storage site. For example, regulatory compliance can comprise EPA subpart H. Once it is verified that the CCUS process is compliant with the first regulation, a CCUS token, which is fiscally agnostic can be minted on the distributed ledger.

The CCUS token can effectively contain all the data spanning capture to storage (or utilization) that can be required for the purpose of verifying that a specific amount of CO₂ (i.e., 1 metric ton of CO₂) has been captured and stored. Further, one or more auditors can be selected based on characteristics of the CCUS process, a set of rules that are applied in conforming to a regulation, a standard/regulation that is applied, or a combination thereof. For example, if an EPA regulation is being tested, then an auditor associated or approved by the EPA can be selected to verify compliance with the regulation. In another example, if the CCUS process is being performed in a specific region, then a specific auditor for verifying compliance in the region can be selected.

If all CCUS token data are determined to be in compliance with predefined regulatory and/or permit requirements, a second CCUS token can be minted. In particular, the second token can be minted according to an applicable technique, such as through a smart contract. The second token can comprise a fiscal token assuring regulatory compliance with a regulation that is a fiscal regulation related to CCUS. For example, a second set of rules can be applied in response to verification that the CCUS process is compliant with the first regulation. More specifically, the second set of rules can be dependent on regulatory compliance with the first regulation. The second set of rules and the corresponding second regulation can comprise fiscal rules for meeting a fiscal regulation, otherwise a regulation associated with value. This is opposed to the fiscally agnostic rules that were applied as the first set of rules. Further, the second token can comprise a derivative token that derives value for meeting a regulation associated with a voluntary CCUS market or a compliance CCUS market. In various embodiments, the second token does not contain the data associated with the CCUS process. Further and in various embodiments, the second token comprises a reference to the first token.

If all CCUS token data are determined to be in compliance with pre-defined carbon standard (e.g., ISO, Verra, etc.), regulatory and/or permit requirements, a third CCUS token can be minted. In some examples, this third token can be assigned the environmental attribute of one metric ton of CO₂ being removed from the atmosphere, and can be transferred as a carbon offset. In some examples, the second and third CCUS tokens can be transferred from the first entity (i.e., ownership transfer), to other third parties. In some embodiments, the tokens can only be transferred once. The tokens can be summarized and/or reported for the purpose of periodic regulatory reporting, tax filings, or other required reporting by the capture facility (capture facility A 402 and capture facility B 404), transport (transport facility 406), and/or storage providers (i.e., storage facility A 408 or storage facility B 410). These capture and storage tokens can represent interfaces between capture/transport and transport/storage, and can be used to trigger payments between entities.

In one embodiment, the one or more input meters 450 and one or more output meters 452 of transport facility 406 can comprise sensors that interface with at least one Supervisory Control and Data Acquisition (“SCADA”) system, and the at least one SCADA system can interface with the at least one distributed and decentralized ledger. For example, the one or more capture facilities (capture facility A 402 and capture facility B 404) SCADA can interface to a distributed and decentralized ledger system to mint capture tokens, and the one or more storage facilities (i.e., storage facility A 408 or storage facility B 410) SCADA can interface to a distributed and decentralized ledger system to mint storage and/or injection tokens.

For example, in facilitating recording of data related to performing a CCUS process (e.g., recording capture data, recording storage data, recording transport data, recording monitoring data, recording injection data, etc.) to a distributed ledger, the distributed ledger can interface with a SCADA system associated with performing the CCUS process. A SCADA system associated with performing a CCUS process can comprise a system that controls or facilitates performance of the CCUS process. For example, a SCADA system can control injection of captured carbon dioxide into a formation. In another example, a SCADA system can monitor the flow of carbon dioxide through a transportation network. In facilitating interfacing between the SCADA system and the distributed ledger, an interface can be provided to the SCADA through which the SCADA can automatically record data to the distributed ledger. Further, an operator can access the SCADA system for data and record the data to the distributed ledger, e.g. through the interface. The one or more SCADA systems can interface with the distributed ledger directly or interface with the distributed ledger through one or more edge devices independent of the one or more SCADA systems.

A CCUS distributed and decentralized ledger system can interface with the capture, storage, and/or injection distributed and decentralized ledger systems. It is appreciated that in a carbon hub network (i.e., carbon hub network 400), there can be more than one SCADA system. Alternatively, an edge device can be included at each sensor of the one or more input meters 450 and one or more output meters 452 of transport facility 406, and transmit sensor data to a third party database to which the distributed and decentralized ledger systems can interface. A verified carbon standard (e.g., ISO 27914, EPA Class VI Subpart RR, etc.) can be applied to the data contained in the injection token to determine if all data is valid. If all data is determined valid, the second CCUS token can be minted for the purpose of demonstrating/meeting regulatory requirements. The value of the second CCUS token may be determined by attributes of the capture token, (e.g., if the 5×multiplier of the credit value (e.g., if storage or EOR, if DAC or point-source capture) for prevailing wage and apprenticeships can be applied, and/or any inflation adjustment factor can be applied). A verified carbon standard (e.g., ISO 27914, EPA Class VI Subpart RR, Verra, etc.) can be applied to the data contained in the first CCUS token to determine if all data is valid. If all data is determined valid, a third token can be minted for the purpose of being a high integrity carbon credit (for example, in voluntary carbon markets). The minting process for the second and third CCUS tokens can also include third party verification (e.g., by an approved third party such as Verra, or by a regulatory body such as the EPA).

Further, the first CCUS token and related distributed and decentralized ledger contains data about the CCUS system performance for a particular capture and utilization/hub relationship. Analysis of the first CCUS token and related distributed and decentralized ledger can form a virtual real time operations (“RTO”) facility that can ensure that the CCUS system is operating within verified carbon standard (“VCS”) parameters. If the system drifts from a VCS parameter, it may no longer be compliant for the purpose of generating the second or third (or any other derivative) CCUS tokens. The virtual RTO can advise the CCUS entities (i.e., capture facilities, transport, storage facilities) of system status and trends, as well as any activities required to ensure the CCUS system remains compliant with verified carbon standards. For example, it can advise that a flow meter calibration will be due for renewal at a given date.

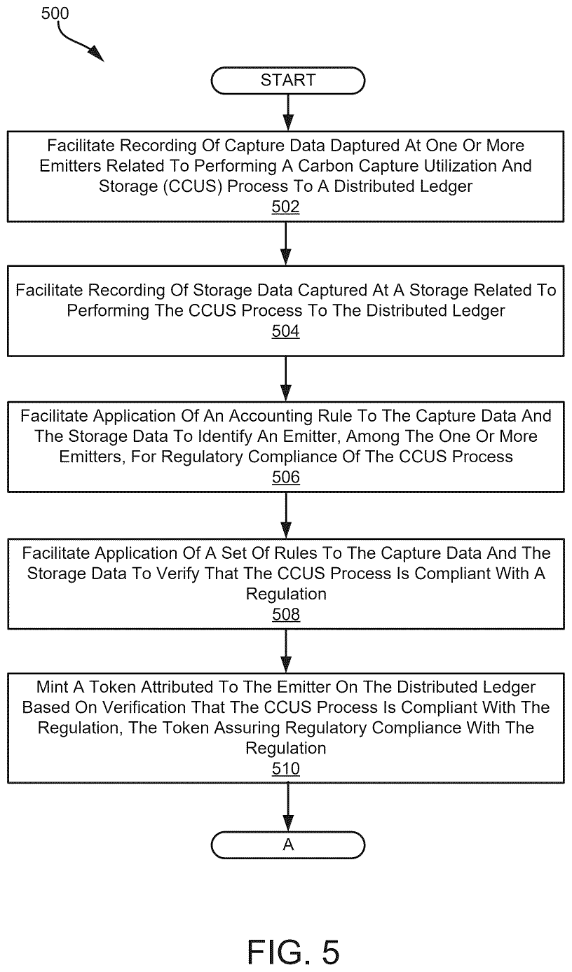

FIG. 5 illustrates a flow diagram of an example process 500 for minting a token attributed to an emitter (i.e., capture facility) on the distributed ledger based on verification that the CCUS process is compliant with the regulation. Process 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Process 500 shall be described with reference to FIG. 4. However, process 500 is not limited to that example.

At block 502, the process 500 can include facilitating recording of capture data captured at one or more emitters (i.e., capture facility A 402 and capture facility B 404) related to performing a carbon capture utilization and storage (CCUS) process to a distributed ledger. For example, a flow meter and/or a composition meter can be positioned at the transport facility to verify that a specific amount of CO₂ (for example, 1 metric ton of CO₂) has been captured and transferred to the transport system. As discussed above, input meter 450 and output meter 452 of transport facility 406 can track and record the amount of the CO₂ provided to the transport facility 406 as well as the source (i.e., specific capture facility) of the CO₂.In some examples, an interface or other applicable system can be provided to an entity associated with performing a CCUS process through which the entity can record data related to performing the CCUS process (e.g., capture data captured at one or more emitters).

At block 504, the process 500 can include facilitating recording of storage data captured at a storage (i.e., storage facility A 408 or storage facility B 410) related to performing the CCUS process to the distributed ledger. For example, output meters 452 of transport facility 406 can comprise a combination of a flow meter and/or a composition meter to verify that a specific amount of CO₂ (i.e., 1 metric ton of CO₂) has been received from the transport facility 406. Storage data can further include, but is not limited to CO₂ mass, identification numbers, permit numbers, surface pressures, temperatures, or any other data required or useful for any regulatory compliance.

At block 506, the process 500 can include facilitating application of an accounting rule to the capture data and the storage data to identify an emitter (i.e., capture facility), among the one or more emitters (for example, capture facility A 402 and/or capture facility B 404), for regulatory compliance of the CCUS process. For example, accounting rules can be created that can attribute the CO₂ flowing through the transport facility to the specific capture facility that provided that CO₂ to the transport facility based on timestamp data (or any other data capable of distinguishing between more than one capture facility). On example method of accounting to relate the storage data (i.e., the amount of CO₂ stored, etc.) to the specific capture facility (“emitter”) that captured the CO₂ includes utilizing the transport provider as a source of inventory that can track the flow of CO₂ through the pipeline. For example, one or more flow meters can be positioned at the input and at the output of the transport provider to track the input and output of CO₂ through the transport facility and associate a timestamp with the measured volume of CO₂. In this manner, accounting rules can be created that can attribute the CO₂ flowing through the transport facility to the specific capture facility that provided that CO₂ to the transport facility based on timestamp data (or any other data capable of distinguishing between more than one capture facility). In one example, a time-stamped first in, first out (“FIFO”) rule can be applied to demonstrate that a first amount of CO₂ added to inventory is the first amount of CO₂ removed from inventory. This accounting rule can enable the linkage of the capture token to storage and injection tokens, and can unlock a CCUS token.

At block 508, the process 500 can include facilitating application of a set of rules to the capture data and the storage data to verify that the CCUS process is compliant with a regulation. As discussed above, regulations, as used herein, can comprise applicable rules and standards that are defined and followed in relation to an aspect of carbon sequestration operations. As discussed previously, the accounting rules discussed above can enable the linkage of the capture token to the storage and injection tokens, thereby unlocking a CCUS token. The CCUS token can effectively contain all the data spanning capture to storage (or utilization) that can be required for the purpose of verifying that a specific amount of CO₂ (i.e., 1 metric ton of CO₂) has been captured and stored. And, at block 510, the process 500 can include minting a token attributed to the emitter on the distributed ledger based on verification that the CCUS process is compliant with the regulation, the token assuring regulatory compliance with the regulation. Specifically, if all CCUS token data are determined to be in compliance with predefined regulatory and/or permit requirements, a second CCUS token can be minted. If all CCUS token data are determined to be in compliance with pre-defined carbon standard (e.g., ISO, Verra, etc.), regulatory and/or permit requirements, a third CCUS token can be minted. In some examples, this third token can be assigned the environmental attribute of one metric ton of CO₂ being removed from the atmosphere, and can be transferred as a carbon offset. In some examples, the second and third CCUS tokens can be transferred from the first entity (i.e., ownership transfer), to other third parties. In some embodiments, the tokens can only be transferred once. The tokens can be summarized and/or reported for the purpose of periodic regulatory reporting, tax filings, or other required reporting by the capture facility (capture facility A 402 and capture facility B 404), transport (transport facility 406), and/or storage providers (i.e., storage facility A 408 or storage facility B 410).

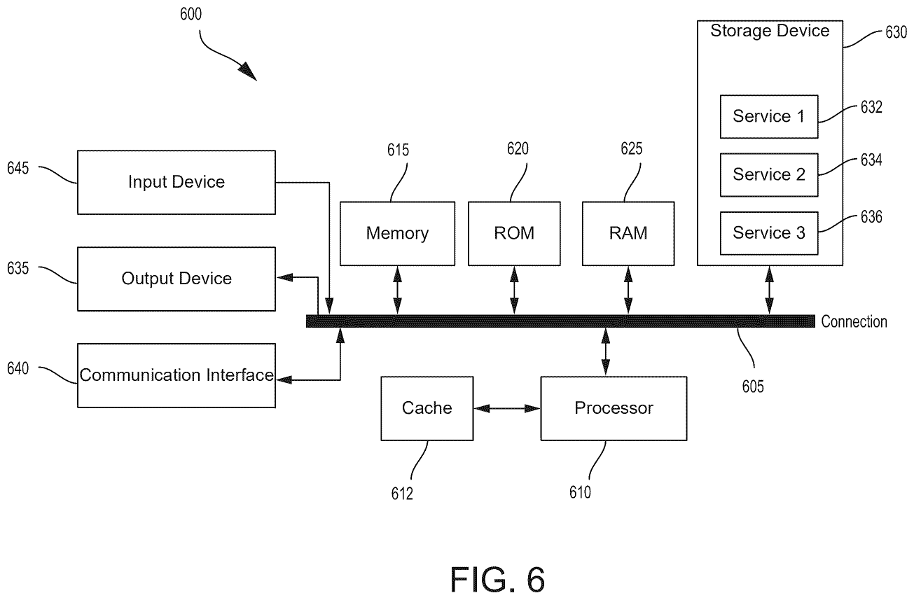

FIG. 6 illustrates an example processor-based system with which some aspects of the subject technology can be implemented. For example, processor-based system 600 can be any computing device, or any component thereof, in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communication interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### SELECTED EXAMPLES

Illustrative examples of the disclosure include:

Aspect 1. A computer-implemented method comprising: facilitating recording of capture data captured at one or more emitters related to performing a carbon capture utilization and storage (CCUS) process to a distributed ledger; facilitating recording of storage data captured at a storage related to performing the CCUS process to the distributed ledger; facilitating application of an accounting rule to the capture data and the storage data to identify an emitter, among the one or more emitters, for regulatory compliance of the CCUS process; facilitating application of a set of rules to the capture data and the storage data to verify that the CCUS process is compliant with a regulation; and minting a token attributed to the emitter on the distributed ledger based on verification that the CCUS process is compliant with the regulation, the token assuring regulatory compliance with the regulation.

Aspect 2. The computer-implemented method of Aspect 1, wherein the accounting rule comprises verifying an amount of carbon capture at the one or more emitters and stored at the storage based on timestamps of the capture data and the storage data.

Aspect 3. The computer-implemented method of either Aspect 1 or 2, wherein the capture data comprises additional data related to the one or more emitters including identification numbers, permit numbers, prevailing wage, apprenticeship information, or a combination thereof.

Aspect 4. The computer-implemented method of any of Aspects 1 through 3, wherein the storage data comprises additional data related to the storage including identification numbers, permit numbers, surface pressures, temperatures, an identifier if the storage is used for permanent storage or for utilization, or a combination thereof.

Aspect 5. The computer-implemented method of any of Aspects 1 through 4, further comprising: facilitating recording of injection data captured at an injection site related to performing the CCUS process to the distributed ledger; and facilitating application of the accounting rule to the injection data in association with the capture data and the storage data to identify the emitter, among the one or more emitters, for regulatory compliance of the CCUS process.

Aspect 6. The computer-implemented method of any of any of Aspects 1 through 5, wherein the injection data comprises additional data related to the injection site including pressures, temperatures, metrics required for regulatory compliance, or a combination thereof.

Aspect 7. The computer-implemented method of any of Aspects 1 through 6, further comprising: gathering the capture data and the storage data related to performing the CCUS process from one or more supervisory control and data acquisition (SCADA) systems in a CCUSS environment; and appending the capture data and the storage data to the distributed ledger.

Aspect 8. The computer-implemented method of any of Aspects 1 through 7, wherein the one or more SCADA systems interface with the distributed ledger directly or interface with the distributed ledger through one or more edge devices independent of the one or more SCADA systems.

Aspect 9. The computer-implemented method of any of Aspects 1 through 8, wherein the set of rules comprise one or more rules related to measuring and verifying an amount of carbon captured at the emitter, storing and verifying an amount of carbon stored at the storage, monitoring and verifying continued storage of the amount of carbon at the storage, or a combination thereof.

Aspect 10. The computer-implemented method of any of Aspects 1 through 9, wherein facilitating application of the set of rules further comprises: providing access to the distributed ledger to one or more entities associated with applying the set of rules to verify regulatory compliance with the regulation; and facilitating recording of verification data indicative of whether the CCUS process is compliant with the set of rules, as determined by the one or more entities, to the distributed ledger.

Aspect 11. The computer-implemented method of Aspect 10, wherein the one or more entities associated with applying the set of rules are selected based on one or more characteristics of the CCUS process, the set of rules, the regulation, or a combination thereof.

Aspect 12. The computer-implemented method of any of Aspects 1 through 11, wherein the token is a fiscally agnostic token, the method further comprising: facilitating application of an additional set of rules to the data to verify the CCUS process is compliant with an additional regulation in response to the verification that the CCUS process is compliant with the regulation; and minting an additional token on the distributed ledger based on verification that the CCUS process is compliant with the additional regulation, the additional token assuring regulatory compliance with the additional regulation.

Aspect 13. The computer-implemented method of Aspect 12, wherein the additional token is a fiscal token assuring regulatory compliance with the additional regulation that is a fiscal regulation related to CCUS.

Aspect 14. The computer-implemented method of Aspect 12, wherein the additional set of rules comprise one or more rules for qualifying for a fiscal carbon credit (tax credit), qualifying for a voluntary carbon credit, or qualifying for a compliance carbon credit (allows certain amount of emission of greenhouse gases).

Aspect 15. The computer-implemented method of Aspect 12, wherein the additional token is a derivative token that derives value for meeting a regulation associated with a voluntary CCUS market or a compliance CCUS market.

Aspect 16. The computer-implemented method of Aspect 12, wherein the additional set of rules are dependent on regulatory compliance with the regulation.

Aspect 17. The computer-implemented method of Aspect 12, wherein facilitating application of the additional set of rules further comprises: providing access to the distributed ledger to one or more entities associated with applying the additional set of rules to verify regulatory compliance with the additional regulation; and facilitating recording of verification data indicative of whether the CCUS process is compliant with the additional set of rules, as determined by the one or more entities, to the distributed ledger.

Aspect 18. The computer-implemented method of Aspect 12, further comprising interacting with an entity associated with performance of the CCUS process regarding compliance with the additional regulation after the verification that the CCUS process is compliant with the regulation.

Aspect 19. A system comprising: one or more processors; and at least one computer-readable storage medium having stored therein instructions which, when executed by the one or more processors, cause the one or more processors to: facilitate recording of capture data captured at one or more emitters related to performing a carbon capture utilization and storage (CCUS) process to a distributed ledger; facilitate recording of storage data captured at a storage related to performing the CCUS process to the distributed ledger; facilitate application of an accounting rule to the capture data and the storage data to identify an emitter, among the one or more emitters, for regulatory compliance of the CCUS process; facilitate application of a set of rules to the capture data and the storage data to verify that the CCUS process is compliant with a regulation; and mint a token attributed to the emitter on the distributed ledger based on verification that the CCUS process is compliant with the regulation, the token assuring regulatory compliance with the regulation.

Aspect 20. A non-transitory computer-readable storage medium storing instructions for causing one or more processors to: facilitate recording of capture data captured at one or more emitters related to performing a carbon capture utilization and storage (CCUS) process to a distributed ledger; facilitate recording of storage data captured at a storage related to performing the CCUS process to the distributed ledger; facilitate application of an accounting rule to the capture data and the storage data to identify an emitter, among the one or more emitters, for regulatory compliance of the CCUS process; facilitate application of a set of rules to the capture data and the storage data to verify that the CCUS process is compliant with a regulation; and mint a token attributed to the emitter on the distributed ledger based on verification that the CCUS process is compliant with the regulation, the token assuring regulatory compliance with the regulation.

Aspect 21. A system comprising means for performing a method according to any of Aspects 1 through 18.

1. A computer-implemented method implemented through one or more processors executing instructions stored on a non-transitory computer-readable storage medium, the method comprising:
facilitating recording of capture data captured at one or more emitters related to performing a carbon capture utilization and storage (CCUS) process to a distributed ledger;
facilitating recording of storage data captured at a storage related to performing the CCUS process to the distributed ledger;
facilitating application of an accounting rule to the capture data and the storage data to identify an emitter, among the one or more emitters, for regulatory compliance of the CCUS process;
facilitating application of a set of rules to the capture data and the storage data to verify that the CCUS process is compliant with at least one national or international government regulation;
minting a token attributed to the emitter on the distributed ledger based on verification that the CCUS process is compliant with the regulation, the token assuring regulatory compliance with the at least one national or international government regulation;
determining, by an operator, whether to trade the minted token, verify the validity of the capture data and the storage data, or vote on a proposed claim; and
performing, by an operator, at least one of the determined trading the minted token, verifying the validity of the capture data and the storage data, and voting on a proposed claim.

2. The computer-implemented method of claim 1, wherein the accounting rule comprises verifying an amount of carbon capture at the one or more emitters and stored at the storage based on timestamps of the capture data and the storage data.

3. The computer-implemented method of claim 1, wherein the capture data comprises additional data related to the one or more emitters including identification numbers, permit numbers, prevailing wage, apprenticeship information, or a combination thereof.

4. The computer-implemented method of claim 1, wherein the storage data comprises additional data related to the storage including identification numbers, permit numbers, surface pressures, temperatures, an identifier if the storage is used for permanent storage or for utilization, or a combination thereof.

5. The computer-implemented method of claim 1, further comprising:
facilitating recording of injection data captured at an injection site related to performing the CCUS process to the distributed ledger; and
facilitating application of the accounting rule to the injection data in association with the capture data and the storage data to identify the emitter, among the one or more emitters, for regulatory compliance of the CCUS process.

6. The computer-implemented method of claim 5, wherein the injection data comprises additional data related to the injection site including pressures, temperatures, metrics required for regulatory compliance, or a combination thereof.

7. The computer-implemented method of claim 1, further comprising:
gathering the capture data and the storage data related to performing the CCUS process from one or more supervisory control and data acquisition (SCADA) systems in a CCUS environment; and
appending the capture data and the storage data to the distributed ledger.

8. The computer-implemented method of claim 7, wherein the one or more SCADA systems interface with the distributed ledger directly or interface with the distributed ledger through one or more edge devices independent of the one or more SCADA systems.

9. The computer-implemented method of claim 1, wherein the set of rules comprise one or more rules related to measuring and verifying an amount of carbon captured at the emitter, storing and verifying an amount of carbon stored at the storage, monitoring and verifying continued storage of the amount of carbon at the storage, or a combination thereof.

10. The computer-implemented method of claim 1, wherein facilitating application of the set of rules further comprises:
providing access to the distributed ledger to one or more entities associated with applying the set of rules to verify regulatory compliance with the regulation; and
facilitating recording of verification data indicative of whether the CCUS process is compliant with the set of rules, as determined by the one or more entities, to the distributed ledger.

11. The computer-implemented method of claim 10, wherein the one or more entities associated with applying the set of rules are selected based on one or more characteristics of the CCUS process, the set of rules, the regulation, or a combination thereof.

12. The computer-implemented method of claim 1, wherein the token is a fiscally agnostic token, the method further comprising:
facilitating application of an additional set of rules to the data to verify the CCUS process is compliant with an additional regulation in response to the verification that the CCUS process is compliant with the regulation; and
minting an additional token on the distributed ledger based on verification that the CCUS process is compliant with the additional regulation, the additional token assuring regulatory compliance with the additional regulation.

13. The computer-implemented method of claim 12, wherein the additional token is a fiscal token assuring regulatory compliance with the additional regulation that is a fiscal regulation related to CCUS.

14. The computer-implemented method of claim 12, wherein the additional set of rules comprise one or more rules for qualifying for a fiscal carbon credit, qualifying for a voluntary carbon credit, or qualifying for a compliance carbon credit.

15. The computer-implemented method of claim 12, wherein the additional token is a derivative token that derives value for meeting a regulation associated with a voluntary CCUS market or a compliance CCUS market.

16. The computer-implemented method of claim 12, wherein the additional set of rules are dependent on regulatory compliance with the regulation.

17. The computer-implemented method of claim 12, wherein facilitating application of the additional set of rules further comprises:
providing access to the distributed ledger to one or more entities associated with applying the additional set of rules to verify regulatory compliance with the additional regulation; and
facilitating recording of verification data indicative of whether the CCUS process is compliant with the additional set of rules, as determined by the one or more entities, to the distributed ledger.

18. The computer-implemented method of claim 12, further comprising interacting with an entity associated with performance of the CCUS process regarding compliance with the additional regulation after the verification that the CCUS process is compliant with the regulation.

19. A system comprising:
one or more processors; and
at least one computer-readable storage medium having stored therein instructions which, when executed by the one or more processors, cause the one or more processors to:
facilitate recording of capture data captured at one or more emitters related to performing a carbon capture utilization and storage (CCUS) process to a distributed ledger;
facilitate recording of storage data captured at a storage related to performing the CCUS process to the distributed ledger;
facilitate application of an accounting rule to the capture data and the storage data to identify an emitter, among the one or more emitters, for regulatory compliance of the CCUS process;
facilitate application of a set of rules to the capture data and the storage data to verify that the CCUS process is compliant with at least one national or international government regulation;
mint a token attributed to the emitter on the distributed ledger based on verification that the CCUS process is compliant with the regulation, the token assuring regulatory compliance with the at least one national or international government regulation;
determine, by an operator, whether to trade the minted token, verify the validity of the capture data and the storage data, or vote on a proposed claim; and
perform, by an operator, at least one of the determined trading the minted token, verifying the validity of the capture data and the storage data, and voting on a proposed claim.

20. A non-transitory computer-readable storage medium storing instructions for causing one or more processors to:
facilitate recording of capture data captured at one or more emitters related to performing a carbon capture utilization and storage (CCUS) process to a distributed ledger;
facilitate recording of storage data captured at a storage related to performing the CCUS process to the distributed ledger;
facilitate application of an accounting rule to the capture data and the storage data to identify an emitter, among the one or more emitters, for regulatory compliance of the CCUS process;
facilitate application of a set of rules to the capture data and the storage data to verify that the CCUS process is compliant with at least one national or international government regulation;
mint a token attributed to the emitter on the distributed ledger based on verification that the CCUS process is compliant with the regulation, the token assuring regulatory compliance with the at least one national or international government regulation;
determining, by an operator, whether to trade the minted token, verify the validity of the capture data and the storage data, or vote on a proposed claim; and
performing, by an operator, at least one of the determined trading the minted token, verifying the validity of the capture data and the storage data, and voting on a proposed claim.
